(19) United States
(12) Patent Application Publication
(10) Pub. No.: US 2015/0251300 A1
(43) Pub. Date: Sep. 10, 2015

(54) ELECTRIC NAIL GUN

(71) Applicant: Basso Industry Corp., Taichung (TW)

(72) Inventors: Chien-Kuo Po, Taichung (TW); Chia-Yu Chien, Taichung (TW); Jian-Rung Wu, Taichung (TW)

(21) Appl. No.: 14/639,631

(22) Filed: Mar. 5, 2015

(30) Foreign Application Priority Data
Mar. 10, 2014 (TW) 103204045

(51) Int. Cl. B25C 1/06

(52) U.S. Cl. CPC B25C 1/06

(57) ABSTRACT

An electric nail gun includes a main frame, a swing arm pivoted to the main frame, an impact member mounted movably to the swing arm, and a restoring mechanism including a sliding member, a first resilient member and a second resilient member. The sliding member is mounted movably to the impact member. The first resilient member is configured such that, when the impact member is driven to move away from a rear end of the swing arm, the sliding member is drawn to move toward a rear end of the impact member by the first resilient member, and the length of the linear deformation of the first resilient member is smaller than the travel distance of the impact member. The second resilient member biases the sliding member away from the rear end of the impact member.

### CROSS-REFERENCE TO RELATED APPLICATION

This application claims priority of Taiwanese Application No. 103204045, filed on Mar. 10, 2014.

### FIELD

The disclosure relates to an electric nail gun, and more particularly to an electric nail gun including a restoring mechanism.

### BACKGROUND

Referring to FIG. 1, Taiwanese Patent Application No. 101110812 discloses a conventional electric nail gun 1 including a main body 10, a nail path 11 that is formed in an end portion of the main body 10, a flywheel 12 that is mounted rotatably to the main body 10, a motor 13 that is mounted to the main body 10 for driving rotation of the flywheel 12, a swing arm 14 that is pivoted to the main body 10, an impact member 15 that is mounted slidably to the swing arm 14, two resilient members 16 (only one is visible) that are connected between the impact member 15 and the main body 10, and a nail striking blade 17 that is connected co-movably to the impact member 15. The resilient members 16 are made of rubber.

The impact member 15 is movable in response to the pivot movement of the swing arm 14 relative to the main body 10 to contact the flywheel 12, and is thereby driven by the flywheel 12 to move along an axis (A) toward the nail path 11 against the biasing action of the resilient members 16, so as to drive the nail striking blade 17 to move within the nail path to perform a nail-striking operation. Afterward, the impact member 15 is drawn by the resilient members 16 to move back to its original position.

In the conventional electric nail gun 1, the length of the linear deformation of the resilient members 16 along the axis (A) is equal to the travel distance of the impact member 15 during the nail-striking operation, so that each of the resilient members 16 has a relatively great extended length, and may fatigue easily and therefore have a short service life.

### SUMMARY

Therefore, an object of the disclosure is to provide an electric nail gun that can overcome the aforesaid drawback associated with the prior art.

According to the disclosure, the electric nail gun includes a main frame, a flywheel, a swing arm, an impact member and a restoring mechanism. The flywheel is mounted rotatably to the main frame and driven by electric power. The swing arm is pivoted to the main frame. The impact member is mounted movably to the swing arm. The swing arm is pivotable relative to the main frame to move the impact member to contact the flywheel so that the impact member is driven by the flywheel to move in a direction of an axis from a normal position where the impact member is proximate to a rear end of the main frame, to a striking position where the impact member is distal from the rear end of the main frame. The restoring mechanism includes at least one sliding member, at least one first resilient member and a second resilient member. The sliding member is mounted to the impact member and movable relative to the impact member in the direction of the axis between a released position and a tensed position. The tensed position is closer to a rear end of the impact member than the released position. The sliding member is at the released position when the impact member is at the normal position. The first resilient member has opposite ends that are connected respectively to a rear end of the swing arm and the sliding member such that, when the impact member is moved from the normal position to the striking position, the sliding member is drawn to move relative to the impact member from the released position to the tensed position by the first resilient member, and the length of the linear deformation of the first resilient member in the direction of the axis is smaller than the travel distance of the impact member from the normal position to the striking position. The second resilient member has opposite ends that are connected respectively to the impact member and the sliding member for biasing the sliding member to the released position when the impact member is at the normal position.

### BRIEF DESCRIPTION OF THE DRAWINGS

Other features and advantages of the disclosure will become apparent in the following detailed description of the embodiment with reference to the accompanying drawings, of which:

FIG. 1 is a side view of a conventional electric nail gun disclosed in Taiwanese Patent Application No. 101110812;

FIG. 2 is an exploded perspective view of an embodiment of an electric nail gun according to the disclosure;

FIG. 3 is a perspective view of the embodiment;

FIG. 4 is a sectional view of the embodiment, illustrating an impact member at a normal position;

FIG. 5 is a side view of the embodiment, illustrating the impact member at a striking position; and

FIG. 6 is another sectional view of the embodiment, illustrating the impact member at the striking position.

### DETAILED DESCRIPTION

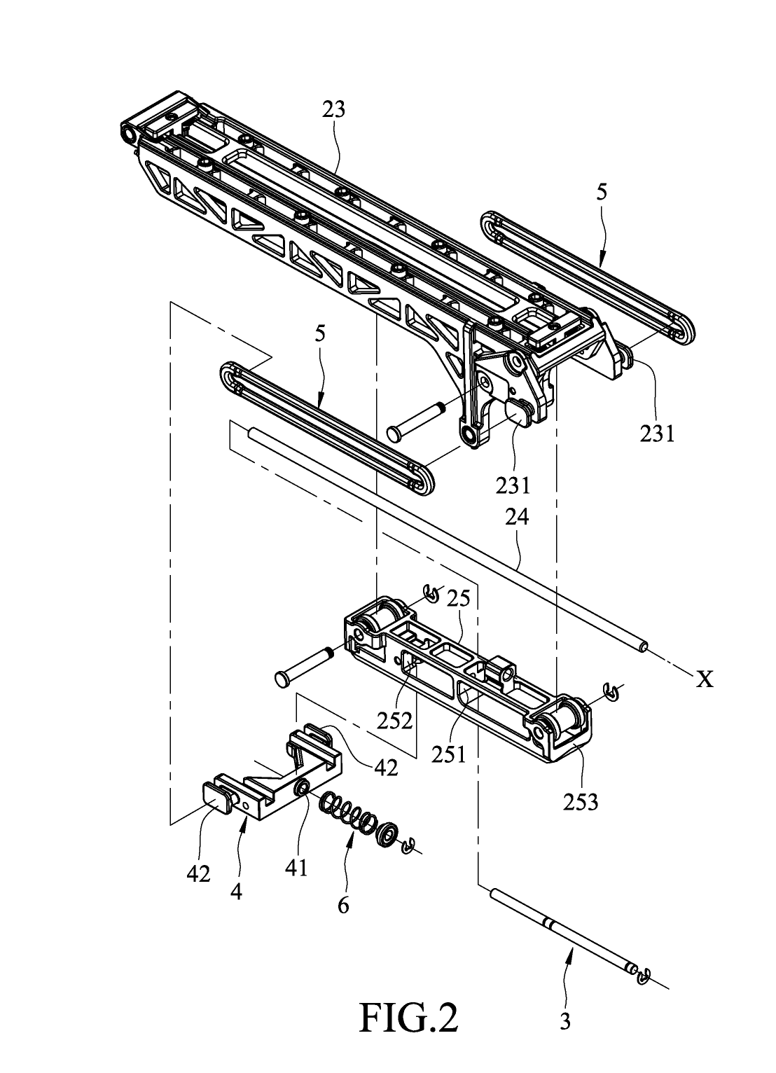

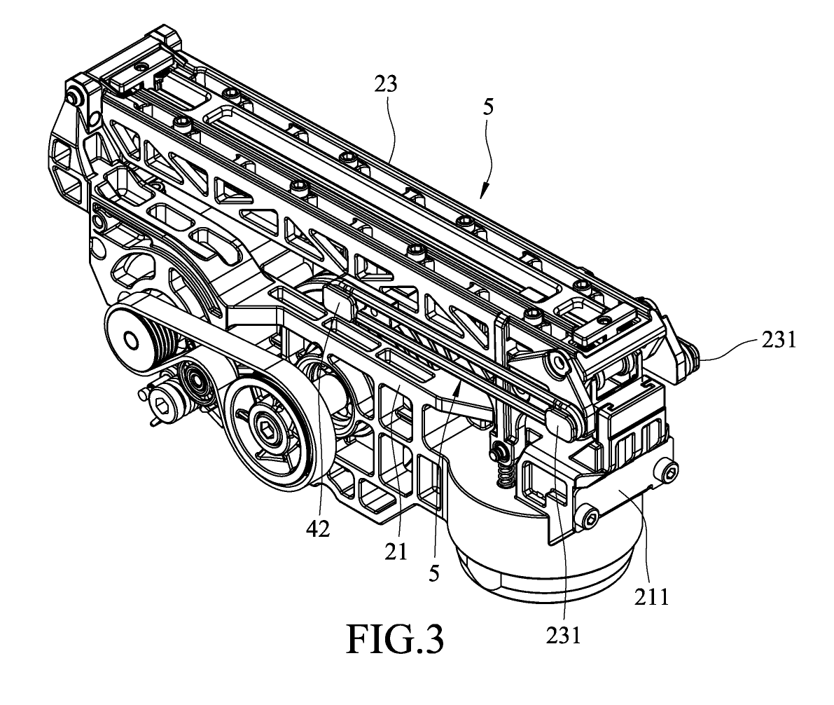

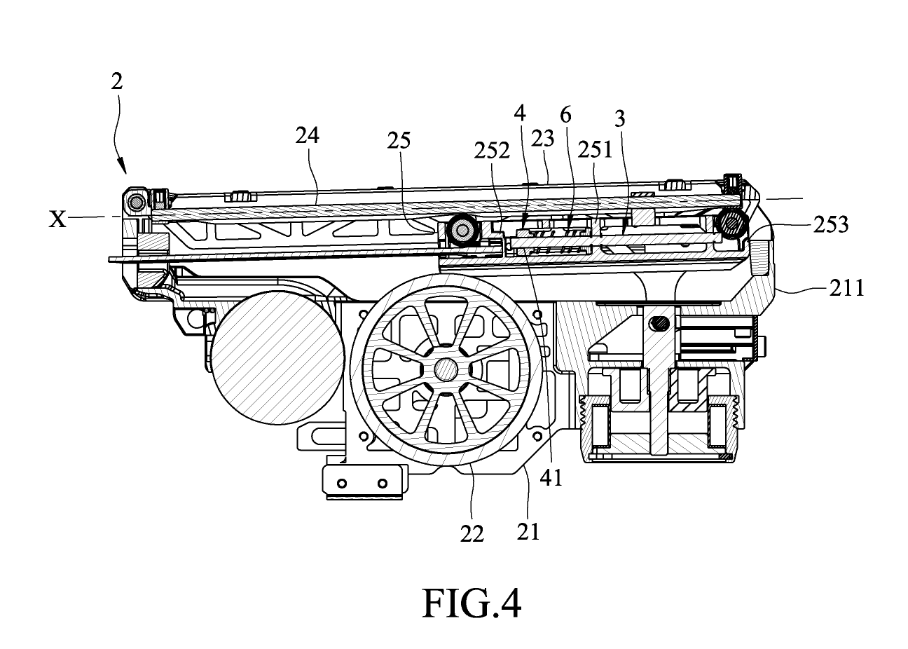

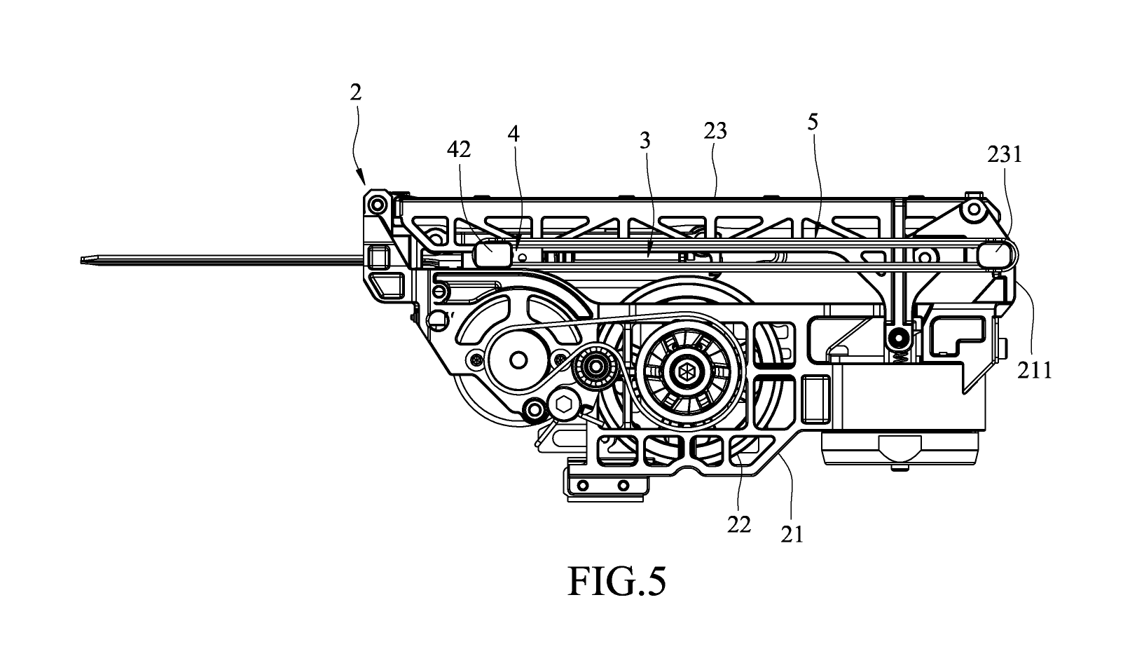

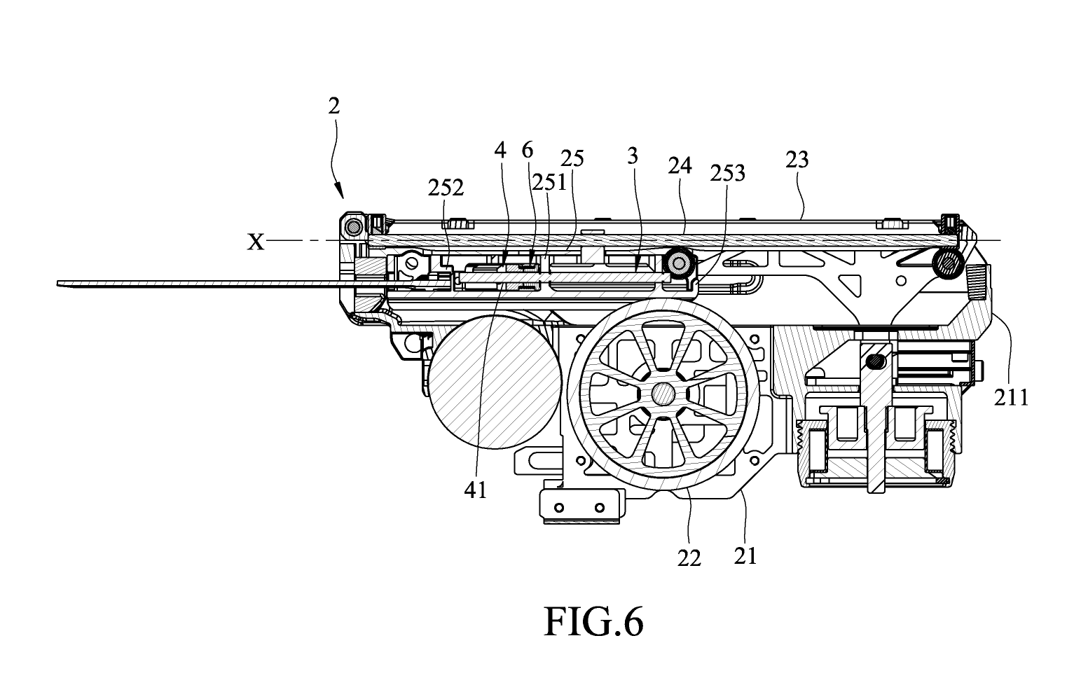

Referring to FIGS. 2 to 4, an embodiment of an electric nail gun 2 according to the present disclosure includes a main frame 21, a flywheel 22 that is mounted rotatably to the main frame 21 and that is driven by electric power, a swing arm 23 that is pivoted to the main frame 21, a guide rod 24 that is mounted in the swing arm 23 and that extends along an axis (X), and an impact member 25 that is mounted to the swing arm 23 and that is movable along the guide rod 24 between a normal position (see FIGS. 3 and 4) where the impact member 25 is proximate to a rear end 211 of the main frame 21, and a striking position (see FIGS. 5 and 6) where the impact member 25 is distal from the rear end 211 of the main frame 21.

The swing arm 23 is pivotable to move the impact member 25 to contact the flywheel 22 so that the impact member 25 is driven by the flywheel 22 to move in the direction of the axis (X) from the normal position to the striking position. The swing arm 23 has two rear hook portions 231 that are connected integrally to a rear end of the swing arm 23, and that are spaced apart from each other in a direction transverse to the direction of the axis (X).

The impact member 25 has first and second stop portions 251, 252 that are spaced apart from each other in the direction of the axis (X). The first stop portion 251 is closer to a rear end 253 of the impact member 25 than the second stop portion 252.

The embodiment of this disclosure further includes a restoring mechanism that includes a guide member 3, a sliding member 4, two first resilient members 5 and a second resilient member 6.

The guide member 3 is configured as a rod that is mounted fixedly to the impact member 25, and that extends in the direction of the axis (X) through the first and second stop portions 251, 252 of the impact member 25.

The sliding member 4 has a central portion that is disposed between the first and second stop portions 251, 252 and that is formed with a through hole 41 for extension of the guide member 3 therethrough, so that the sliding member 4 is movable relative to the impact member 25 in the direction of the axis (X) between a released position (see FIG. 4) and a tensed position (see FIG. 6). The tensed position is closer to the rear end 253 of the impact member 25 than the released position. The sliding member 4 further has two front hook portions 42 that are spaced apart from each other in the direction transverse to the direction of the axis (X) and that correspond respectively to the rear hook portions 231. The sliding member 4 is at the released position when the impact member 25 is at the normal position.

Each of the first resilient members 5 is configured as a rubber ring, and has opposite ends that are hooked respectively on a respective one of the rear hook portions 231 and a corresponding one of the front hook portions 42.

The second resilient member 6 is configured as a compression spring that is sleeved on the guide member 3, and that has opposite ends connected respectively to the first stop portion 251 of the impact member 25 and the sliding member 4 for biasing the sliding member 4 to the released position when the impact member 25 is at the normal position.

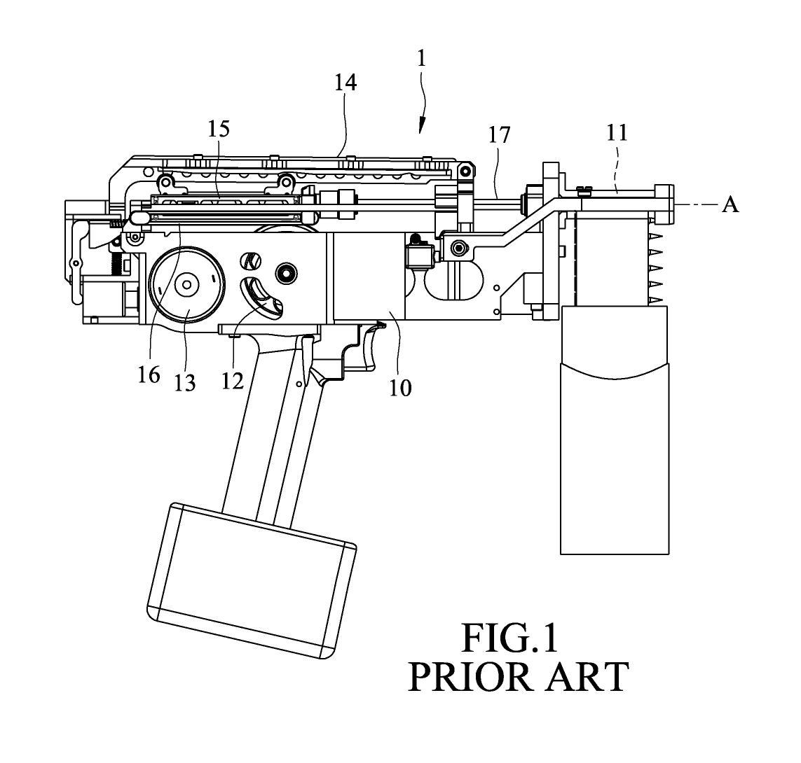

Referring to FIGS. 5 and 6, when the impact member 25 is driven by the flywheel 22 to move from the normal position to the striking position, the first resilient members 5 are stretched in the direction of the axis (X) to generate a restoring force . Therefore, the sliding member 4 is drawn by the first resilient members 5 to move relative to the impact member 25 from the released position to the tensed position against the biasing action of the second resilient member 6. As a result, the length of the linear deformation of each of the first resilient members 5 in the direction of the axis (X) is smaller than the travel distance of the impact member 25 from the normal position to the striking position, so that each of the first resilient members 5 has a relative small extended length compared with the resilient members 16 (see FIG. 1) of the conventional electric nail gun 1, and may therefore have a prolonged service life.

Referring back to FIGS. 3 and 4, when the impact member 25 is drawn back to the normal position by the first resilient members 5, the sliding member 4 is biased to move back to the released position by the second resilient member 6.

It is noted that the second resilient member 6 may be configured as an extension spring that has opposite ends connected respectively to the second stop portion 252 of the impact member 25 and the sliding member 4 for biasing the sliding member 4 to the released position when the impact member 25 is at the normal position.

The advantages of this disclosure are as follows:

1. Since the sliding member 4 is drawn by the first resilient members 5 to move to the tensed position when the impact member 25 is moved to the striking position, each of the first resilient members 5 has a relatively small extended length compared with the resilient members 16 (see FIG. 1) of the conventional electric nail gun 1, and therefore has a prolonged service life.

2. The sliding member 4 and the second resilient member 6 are mounted on the impact member 25, and are configured not to occupy an additional space of the main frame 21. The second resilient member 6 biases the sliding member 4 to the released position when the impact member 25 is at the normal position.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An electric nail gun comprising:
a main frame;
a flywheel mounted rotatably to said main frame and driven by electric power;
a swing arm pivoted to said main frame;
an impact member mounted movably to said swing arm, said swing arm being pivotable relative to said main frame to move said impact member to contact said flywheel so that said impact member is driven by said flywheel to move in a direction of an axis from a normal position where said impact member is proximate to a rear end of said main frame, to a striking position where said impact member is distal from said rear end of said main frame; and
a restoring mechanism including at least one sliding member, at least one first resilient member and a second resilient member, said sliding member being mounted to said impact member and movable relative to said impact member in the direction of the axis between a released position and a tensed position, the tensed position being closer to a rear end of said impact member than the released position, said sliding member being at the released position when said impact member is at the normal position, said first resilient member having opposite ends that are connected respectively to a rear end of said swing arm and said sliding member such that, when said impact member is moved from the normal position to the striking position, said sliding member is drawn to move relative to said impact member from the released position to the tensed position by said first resilient member, and the length of the linear deformation of said first resilient member in the direction of the axis is smaller than the travel distance of said impact member from the normal position to the striking position, said second resilient member having opposite ends that are connected respectively to said impact member and said sliding member for biasing said sliding member to the released position when said impact member is at the normal position.

2. The electric nail gun as claimed in claim 1, wherein said swing arm has two rear hook portions that are connected integrally to said rear end thereof and that are spaced apart from each other in a direction transverse to the direction of the axis, said sliding member having two front hook portions that are spaced apart from each other in the direction transverse to the direction of the axis and that correspond respectively to said rear hook portions, said restoring mechanism including two said first resilient members, each of said first resilient members having opposite ends that are hooked respectively on a respective one of said rear hook portions and a corresponding one of said front hook portions.

3. The electric nail gun as claimed in claim 1, wherein said re storing mechanism further includes a guide member that is mounted fixedly to said impact member, said sliding member being movable on said guide member in the direction of the axis.

4. The electric nail gun as claimed in claim 3, wherein said guide member is configured as a rod extending in the direction of the axis, and said sliding member is formed with a through hole for extension of said guide member therethrough, said second resilient member being sleeved on said guide member.

5. The electric nail gun as claimed in claim 4, wherein said impact member has first and second stop portions that are spaced apart from each other in the direction of the axis, said first stop portion being closer to said rear end of said impact member than said second stop portion, said sliding member having a portion that is disposed between said first and second stop portions, said guide member extending through said first and second stop portions and said portion of said sliding member, said opposite ends of said second resilient member being connected respectively to said first stop portion and said sliding member.

6. The electric nail gun as claimed in claim 1, wherein said first resilient member is configured as a rubber ring.

7. The electric nail gun as claimed in claim 1, wherein said second resilient member is configured as a compression spring.
